(19) United States
(12) Patent Application Publication
(10) Pub. No.: US 2026/0202688 A1
(43) Pub. Date: Jul. 16, 2026

(54) ELECTRONIC MYOPIA GLASSES AND METHOD FOR USING THE SAME

(71) Applicant: Anhui Avatar Sanjiewai Technology Co., Ltd., Hefei (CN)

(72) Inventors: Zhenhu Ding, Hefei (CN); Xiuyong Sun, Hefei (CN); Jinbao Qian, Hefei (CN); Congcong Jiang, Hefei (CN); Zhe Liu, Hefei (CN); Yi Chen, Hefei (CN); Peizheng Yan, Hefei (CN)

(21) Appl. No.: 19/366,350

(22) Filed: Oct. 22, 2025

(30) Foreign Application Priority Data
Jan. 15, 2025 (CN) 202510061011.9

(51) Int. Cl. G02C 11/00; G02C 7/08; G06T 3/40; H04N 23/90

(52) U.S. Cl. CPC G02C 11/10; G02C 7/081; G06T 3/40; H04N 23/90

(57) ABSTRACT

Electronic myopia glasses comprises a glasses frame, a focusing camera module arranged on the glasses frame, a main board and a catadioptric optical display module; the catadioptric optical display module comprises a microchip display screen and a catadioptric optical display lens group; wherein a diopter adjustment of the electronic myopia glasses is achieved by adjusting a distance between the catadioptric optical display lens groups or a distance between the catadioptric optical display lens group and the display screen; wherein the focusing camera module collects an image of a real world and transmits them to the main board, which processes an image signal and transmits it to the microchip display screen for display; the display screen projects the image to the lens group, which changes an optical path to enlarge the image to a size of 1:1 with a real scene, and directly projects the optical path into eyes.

### CROSS-REFERENCE TO RELATED APPLICATION

The present application claims priority to Chinese patent application No. 202510061011.9, entitled “ELECTRONIC MYOPIA GLASSES AND METHOD FOR USING THE SAME”, filed on January 15, 2025, the disclosure of which is hereby incorporated by reference in its entirety. No new matter has been introduced.

### TECHNICAL FIELD

The present disclosure relates to the technical field of myopia correction, and particularly to electronic myopia glasses and method for using the same.

### BACKGROUND

According to statistics from the World Health Organization (WHO), the prevalence of myopia is increasing worldwide, and the number of myopic people in the world has exceeded 2 billion. From a geographical distribution perspective, Asia has the highest myopia rate, with China and Singapore both exceeding 80%. In addition, myopia rates in European and American countries are also gradually increasing, especially among young people. Statistics show that China is not only the world's largest myopic country, with nearly 700 million myopic people, but also the country with the highest myopia incidence rate, with an urban adolescent myopia incidence rate of 67%.

The current mainstream method is to correct daily vision by wearing myopia glasses. Myopia glasses are glasses that are used to correct vision and allow people to clearly see objects at a distance. The purpose is to keep the ciliary muscles of the eyeballs in a certain degree of regulation ability. Myopia glasses are concave lenses. The diopter of the glasses is generally expressed in degrees. A diopter is equal to 100 degrees that ordinary people or glasses shops say. However, if the degrees of the glasses are inaccurate, whether they are over-corrected or under-corrected, they will lead to blurred vision, forcing the eyes to be over-regulated, thereby accelerating the development of myopia. In addition, if the glasses are of poor quality, such as wear of the glasses, or the wear method is incorrect, it will also affect the corrective effect of vision. The more serious the vision problem, the deeper the glasses degree required, and the higher the glasses thickness. Moreover, the degree of traditional glass or resin myopia glasses is fixed after being fitted with glasses, and cannot be suitable for different usage scenarios. For example, the diopter adjustment requirements for reading, watching computers, watching TV, watching blackboards and projection screens of PPT are not consistent. The fixed degree of glasses will inevitably make the user unable to see the target very relaxedly in at least one scenario, resulting in excessive squinting and tightening of the crystalline lens. In the long run, this will inevitably lead to an increase in myopia degree and may also cause other eye diseases.

In addition, before the age of 30, the glasses degrees of myopia population, especially the developing adolescents, will gradually increase, and basically need to replace myopia glasses with a higher degree in about 1-2 years. However, after the age of 30, as you get older, the eye-related muscles become loose, the myopia degree will gradually decrease, and there is also a need to change myopia glasses with a lower degree. Wearing glasses of the right degree can not only ensure a clear vision, but also help the health of the eyes. However, myopia glasses are often hundreds or thousands of yuan, and they need to go to professional institutions for optometry and fitting, which is a huge time cost and economic burden for myopia people.

Therefore, the present disclosure will provide electronic myopia glasses with a simple structure that can accurately adjust diopters according to the user's situation has become an urgent problem.

### SUMMARY

The purpose of the present disclosure is to solve the disadvantages existing in the prior art and to provide electronic myopia glasses.

To achieve the above-mentioned purpose, the present disclosure adopts the following technical solutions.

An electronic myopia glasses, comprising a glasses frame, a focusing camera module arranged on the glasses frame, a main board and a catadioptric optical display module; the catadioptric optical display module comprises a microchip display screen and a catadioptric optical display lens group; wherein a diopter adjustment of the electronic myopia glasses is achieved by adjusting a distance between the catadioptric optical display lens groups or a distance between the catadioptric optical display lens group and the display screen; wherein the focusing camera module collects an image of a real world and transmits them to the main board, which processes an image signal and transmits it to the microchip display screen for display; the microchip display screen projects the image to a catadioptric optical display lens group, which changes an optical path to enlarge the image to a size of 1:1 with a real scene, and directly projects the optical path into eyes of a user, thus the user can see a scene that is 1:1 with the real world and a scene seen is naturally connected with a scene seen by a peripheral vision of the user without overlapping, which is the same as the traditional resin glasses effect.

In some embodiments, the glasses frame comprises a glass front panel, a glass back cover, and temples, the glass back cover is provided with a nose pad.

In some embodiments, the focusing camera module comprises a focusing camera, a camera fixing block and a camera cover plate, the focusing camera is installed on the glass front panel by the camera fixing block, and the camera cover plate is covered on the focusing camera. The focusing camera module is provided for each of left and right eyes, and is arranged at a position of a vertical center line of an eyeball of a user, and two cameras are in a position of a same horizontal line. The field angle of the individual camera is greater than or equal to 110 degrees, and the overlap angle of the field angle of cameras is no less than 110. Each peripheral vision of the user is the same as existing resin or glass myopia glasses (natural light) at 30 degrees, and the catadioptric optical display lens group and the camera are selected accordingly to ensure that the user obtains the best field angle.

In some embodiments, the electronic myopia glasses further comprise a power supply module, which is configured to supply power to the binocular focusing camera module, the main board, and the optical display module.

In some embodiments, the power supply module is a split uninterrupted power supply module, each temple is provided with a power supply interface, and a battery of the power supply module is placed on a waist or a neck of the user, and is connected to the power supply interface of each temple by a power cord. The total weight of the power supply module is within 100g.

In some embodiments, the power supply module can be powered by a built-in power supply or a removable power supply.

In some embodiments, the power supply module is installed in the glasses frame, and preferably is arranged in the temple.

In some embodiments, the main board further comprises a heat dissipation board, which is used for heat dissipation of the main board.

The present disclosure further discloses a method for using electronic myopia glasses, comprising:

step 1: adjusting, a diopter adjustment of the electronic myopia glasses by adjusting a distance between the catadioptric optical display lens groups or a distance between the catadioptric optical display lens group and the display screen;

step 2: colleting, an image of a real world by a camera, and transmitting to the main board of the electronic myopia glasses;

step 3: processing, an image signal by the main board of the electronic myopia glasses; and

step 4: transmitting, the image signal processed by the main board to the microchip display screen for display, and the user can use electronic myopia glasses to view the real world.

In some embodiments, the diopter adjustment of step 1 comprises a coarse adjustment and a fine adjustment, and specifically comprises:

rotating, left and right lens barrels to a corresponding diopter scale according to a current myopia degree of the user;

displaying, a vision mark on one display screen, and fine-tuning the corresponding lens barrel until a clearest visual effect being achieved; and

displaying, a vision mark on another display screen, and fine-tuning a corresponding lens barrel until the clearest visual effect being achieved; the vision mark is a letter, a number, a text, or an image; and

displaying, vision marks on left and right display screens, and fine-tuning the lens barrels until the clearest visual effect being achieved for the eyes of the user.

In some embodiments, when adjusting to match the diopter of the left eye of a user, the right display screen is black or the entire black pattern is displayed, or the right eye of the user is blocked, and vice versa.

In some embodiments, the vision mark on the display screen selects a corresponding distance according to the object distance in the usage scenario of the user to adjust the diopter.

In some embodiments, when performing binocular diopter adjustment, the array-type vision mark is adopted, which can simulate vision mark at different distances, and can also collect vision mark at different distances and different array positions in advance by the focusing camera module. For example, letter E arranged in a nine-grid array or letter E arranged in a circle is used.

In some embodiments, first, a vision mark of a corresponding distance is selected according to the object distance in the usage scenario of the user to perform binocular diopter adjustment. For example, if the user mainly uses it at close range (computer office or desk writing, etc.), a vision mark simulating a distance of 1-2 meters is selected to perform a diopter adjustment. If the user is active indoors, a vision mark simulating a distance of 5-8 meters is selected to perform a diopter adjustment. If the user is outdoors, a vision mark simulating a distance of more than 10 meters is selected to perform a diopter adjustment. The diopter adjustment is performed according to the object distance of the usage scenario to ensure the relaxation and comfort of the user's eyes to the greatest extent and protect the user's vision health. Then, the letter E at different positions in the array is lit up in turn on the display screen, and the lens barrels corresponding to the left and right eyes are adjusted to obtain the best visual effect.

In some embodiments, in the vision mark array, adjacent vision marks are in different colors.

In some embodiments, the vision mark is a letter, a number, a text, or an image.

In some embodiments, the step 1 further comprises: adjusting a focus by using a binocular focusing camera module according to an observation distance.

In some embodiments, step 1 further comprises: adjusting a distance between the binocular camera and a corresponding display according to a pupil distance of the user.

In some embodiments, the step 2 comprises an image processing step and an image fusion step, wherein the image processing step comprises performing bad pixel correction, white balance, color correction, denoising, distortion correction, and color adjustment for the image; and the image fusion step comprises fusing a parallax of left and right eye images, optical anti-distortion and anti-dispersion of binocular images, and binocular image rendering.

It should be noted that, in the above steps, the diopter adjustment in step1 can also be performed after steps 2 and 3. The vision mark used for diopter adjustment in step 1 can be directly displayed in the collected real scene, or the vision mark can be placed at a suitable position in the real scene to cooperate with the diopter adjustment, or the scenery in the real scene can be used as a reference vision mark.

In addition, the electronic myopia glasses provided by the present disclosure can also be set with a diopter lower than the current myopia degree of the user in accordance with the doctor's advice to restore myopia and continuously improve the user's myopia state.

Compared with the prior art, the advantages and positive effects of the present disclosure are: the electronic myopia glasses provided by the present disclosure are simple in structure and light in weight. The weight of the glasses does not exceed 90g, and the user will not feel tired after wearing them for a long time.

The electronic myopia glasses provided by the present disclosure can be adjusted accurately and timely according to the current myopia situation of the user, and the diopter will not be over-corrected or under-corrected, which can put the user's eyes in the most relaxed working state, relieve visual fatigue, and effectively protect the health of the user's eyes.

The myopic users wearing the electronic myopia glasses provided by the present disclosure can adjust the diopter of the eyes in real time, which can replace traditional glass or resin myopia glasses and does not need to frequently replace glasses, thereby reducing the long-term use cost of users and having high economic value.

The electronic myopia glasses provided by the present disclosure can adjust the diopter according to the current usage scenario of the user, ensuring that the user can see the target clearly when relaxed, which is beneficial to the user's vision health.

### BRIEF DESCRIPTION OF DRAWINGS

FIG. 1 is a schematic diagram of an overall structure according to electronic myopia glasses of the present disclosure.

FIG. 2 is a schematic diagram of an overall structure according to electronic myopia glasses of Embodiment 1 of the present disclosure.

FIG. 3 is a schematic diagram of an overall structure according to electronic myopia glasses of Embodiment 2 of the present disclosure.

FIG. 4 is a schematic diagram of an overall structure according to electronic myopia glasses of Embodiment 3 of the present disclosure.

### Reference Signs

1-glass front panel; 2-focusing camera module; 21-focusing camera; 22-camera fixing block; 23-camera cover plate; 3-main board; 31-heat dissipation board; 4-catadioptric optical display module; 41-catadioptric optical display lens group; 42-miniature display screen; 5-glass back cover; 51-nose pad; 6-temples; 61-inner shell; 62-outer shell; 63-power supply connection portion; 64-detachable power supply module.

### DETAILED DESCRIPTION

In order to more clearly explain the overall concept of the present disclosure, the following is a detailed description in combination with the drawings of the specification by a way of example.

It should be noted that many specific details are described in the following description to facilitate a full understanding of the present disclosure, but the present disclosure can also be implemented in other ways different from those described herein, and therefore, the protection scope of the present disclosure is not limited by the specific embodiments disclosed below.

In addition, in the description of the present disclosure, it should be understood that the terms "center", "upper", "lower", "front", "back", "left", "right", "vertical", "horizontal", "top", "bottom", "inner", "outer", "axial", "radial", "circumferential" and the like indicate orientations or positional relationships based on the orientations or positional relationships shown in the drawings, which are only for the convenience of describing the present disclosure and simplifying the description, and do not indicate or imply that the device or element referred to must have a specific orientation, be constructed and operated in a specific orientation, and therefore cannot be understood as a limitation of the present disclosure.

In the present disclosure, unless otherwise clearly specified and limited, the terms "installed", "coupled", "connected", "fixed" and the like should be understood in a broad sense, for example, it can be a fixed connection, a detachable connection, or an integral body. It can be directly connected or indirectly connected by an intermediate medium, and it can be the internal connection of two elements or the interaction relationship between two elements. However, if it is indicated as directly connected, it means that the two connected bodies do not establish a connection relationship by a transition structure, but are only connected by a connecting structure to form a whole. For those skilled in the art, the specific meanings of the above terms in the present disclosure can be understood according to the specific circumstances.

In the present disclosure, unless otherwise clearly defined and limited, the first feature "on" or "under" the second feature can be that the first and second features are in direct contact, or the first and second features are in indirect contact by an intermediate medium. In the description of this specification, the description of reference terms "one embodiment", "some embodiments", "example", "specific example" or "some examples" etc. means that the specific features, structures, materials or characteristics described in conjunction with the embodiment or example are included in at least one embodiment or example of the present disclosure. In this specification, the schematic representation of the above terms is not necessarily directed to the same embodiment or example. Moreover, the specific features, structures, materials or characteristics described can be combined in any one or more embodiments or examples in a suitable manner.

Embodiment 1

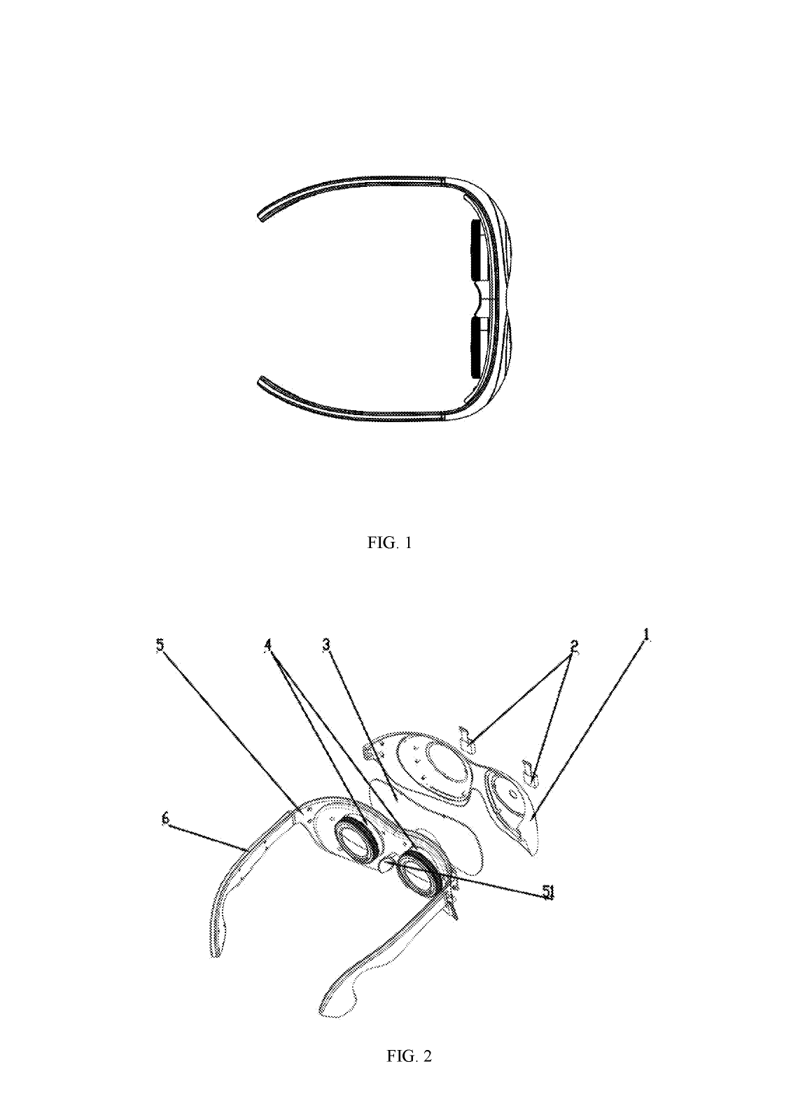

As shown in FIGS. 1 and 2, the present disclosure provides electronic myopia glasses, the glasses frame comprises a glass front panel 1, a glass back cover 5 and a temple 6, the glass back cover 5 is provided a nose pad 51, a focusing camera module 2, a main board 3 and a catadioptric optical display module 4 arranged on the glasses frame. The catadioptric optical display module 4 comprises a catadioptric optical display lens group 41 and a display screen 42. A distance between the catadioptric optical display lens groups can be adjusted to achieve diopter adjustment.

The focusing camera module 21 is arranged at a position of a vertical center line of an eyeball of a user, and two cameras are in a position of a same horizontal line. The field angle of the individual camera is greater than or equal to 110 degrees, and the overlap angle of the field angle of cameras is no less than 110. Each peripheral vision of the user is the same as existing resin or glass myopia glasses (natural light) at 30 degrees, and the catadioptric optical display lens group 41 and the camera are selected accordingly to ensure that the user obtains the best field angle.

The electronic myopia glasses further comprise a power supply module, which is configured to use a power supply interface of a power cord connected to the temples 6 to supply power to the binocular focusing camera module 2, the main board 3, and the optical display module 4. The total weight of the power supply module is less than 100g.

The focusing camera module 2 collects an image of a real world and transmits them to the main board 3, which processes an image signal and transmits it to the microchip display screen 42 for display. The microchip display screen 42 projects the image to a catadioptric optical display lens group 41, which changes an optical path to enlarge the image to a size of 1:1 with a real scene, and directly projects the optical path into eyes of a user, thus the user can see a scene that is 1:1 with the real world and a scene seen is naturally connected with a scene seen by a peripheral vision of the user without overlapping, which is the same as the traditional resin glasses effect.

A method for using electronic myopia glasses comprises:

step 1: adjusting, a diopter to match the user, by adjusting a distance between the catadioptric optical display lens groups; specifically comprises:

1-1: rotating, left and right lens barrels to a corresponding diopter scale according to a current myopia degree of the user;

1-2: displaying, a vision mark on one display screen, and fine-tuning the corresponding lens barrel until a clearest visual effect being achieved; and

1-3: displaying, a vision mark on another display screen, and fine-tuning a corresponding lens barrel until the clearest visual effect being achieved.

The vision marks are displayed on left and right display screens, and fine-tuning the lens barrels until the clearest visual effect being achieved for the eyes of the user. When adjusting to match the diopter of the left eye of a user, the right display screen is black or the entire black pattern is displayed, or the right eye of the user is blocked, and vice versa.

When performing binocular diopter adjustment, the array-type vision mark is adopted, which can simulate vision mark at different distances, and can also collect vision mark at different distances and different array positions in advance by the focusing camera module. For example, letter E arranged in a nine-grid array or letter E arranged in a circle is used. First, a vision mark of a corresponding distance is selected according to the object distance in the usage scenario of the user to perform binocular diopter adjustment. For example, if the user mainly uses it at close range (computer office or desk writing, etc.), a vision mark simulating a distance of 1-2 meters is selected to perform a diopter adjustment. If the user is active indoors, a vision mark simulating a distance of 5-8 meters is selected to perform a diopter adjustment. If the user is outdoors, a vision mark simulating a distance of more than 10 meters is selected to perform a diopter adjustment. The diopter adjustment is performed according to the object distance of the usage scenario to ensure the relaxation and comfort of the user's eyes to the greatest extent and protect the user's vision health. Then, the letter E at different positions in the array is lit up in turn on the display screen, and the lens barrels corresponding to the left and right eyes are adjusted to obtain the best visual effect. In some embodiments, in the vision mark array, adjacent vision marks are in different colors.

Step 2: colleting, an image of a real world by a focusing camera module 2, and transmitting to the main board 3 of the electronic myopia glasses.

Step 3: processing, an image signal by the main board 3 of the electronic myopia glasses, and comprising an image processing step and an image fusion step.

3-1: The image processing step comprises performing bad pixel correction, white balance, color correction, denoising, distortion correction, and color adjustment for the image; and

3-2: The image fusion step comprises fusing a parallax of left and right eye images, optical anti-distortion and anti-dispersion of binocular images, and binocular image rendering.

Step 4: transmitting, the image signal processed by the main board 3 to the microchip display screen for display, the myopic users can use electronic myopia glasses to view the real world.

Embodiment 2

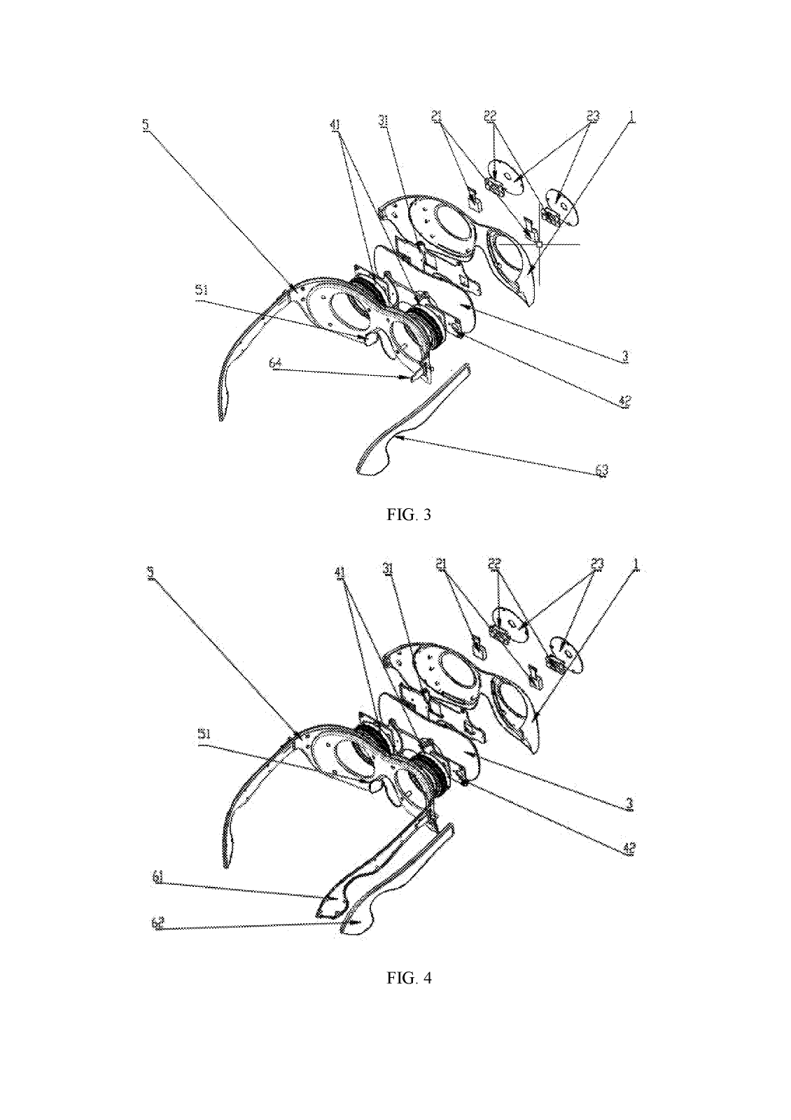

As shown in FIGS. 1 and FIG. 3, the present disclosure provides electronic myopia glasses, comprising a glass front panel 1, a glass back cover 5 and temples 6, wherein the glass back cover 5 is provided with a glasses frame composed of a nose pad 51, and a focusing camera module 2, a main board 3 and a catadioptric optical display module 4 are arranged on the glasses frame. The focusing camera module 2 comprises a focusing camera 21, a camera fixing block 22 and a camera cover plate 23. The focusing camera 21 is installed on the glass front panel 1 by the camera fixing block 22, and the camera cover plate 23 is covered on the focusing camera 21. The main board 3 further comprises a heat dissipation board 31, and the heat dissipation board 31 is used for heat dissipation of the main board 3.

The catadioptric optical display module 4 comprises a catadioptric optical display lens group 41 and a microchip display screen 42. A distance between the catadioptric optical display lens group 41 and the display screen 42 can be adjusted to achieve the diopter adjustment.

The focusing camera module 21 is arranged at a position of a vertical center line of an eyeball of a user, and two cameras are in a position of a same horizontal line. The field angle of the individual camera is greater than or equal to 120 degrees, and the overlap angle of the field angle of cameras is no less than 120. Each peripheral vision of the user is the same as existing resin or glass myopia glasses (natural light) at 30 degrees, and the catadioptric optical display lens group 41 and the camera are selected accordingly to ensure that the user obtains the best field angle.

The electronic myopia glasses further comprise a detachable power supply module 64 installed on the temples 6, and the detachable power supply module 64 is connected to the temples through a power supply connection portion 63 on the temples 6. The detachable power supply module can be used as a detachable part of the temples 6, and is used to supply power to the binocular focusing camera module 2, the main board 3 and the optical display module 4.

The focusing camera module 2 collects images of the real world and transmits them to the main board 3. The main board 3 processes the image signals and transmits them to the microchip display screen 42 for display. The myopic user sees the images of the real world displayed by the microchip display screen 42 by the catadioptric optical display lens group 41.

The total weight of electronic myopia glasses is within 90g, and users will not feel uncomfortable due to excessive weight when wearing them for a long time.

A method for using electronic myopia glasses comprises:

step 1: adjusting, a diopter to match the user, using a lens barrel, by adjusting a distance between the catadioptric optical display lens group and the display screen; specifically comprises:

1-1: rotating, left and right lens barrels to a corresponding diopter scale according to a current myopia degree of the user;

1-2: displaying, a vision mark on one display screen, and fine-tuning the corresponding lens barrel until a clearest visual effect being achieved;

1-3: displaying, a vision mark on another display screen, and fine-tuning a corresponding lens barrel until the clearest visual effect being achieved; and

1-4: displaying, the vision marks on left and right display screens, and fine-tuning the lens barrels until the clearest visual effect being achieved for the eyes of the user.

When adjusting to match the diopter of the left eye of a user, the right display screen is black or the entire black pattern is displayed, or the right eye of the user is blocked.

When performing binocular diopter adjustment, the array-type vision mark is adopted, which can simulate vision mark at different distances, and can also collect vision mark at different distances and different array positions in advance by the focusing camera module. For example, letter E arranged in a nine-grid array or letter E arranged in a circle is used. First, a vision mark of a corresponding distance is selected according to the object distance in the usage scenario of the user to perform binocular diopter adjustment. For example, if the user mainly uses it at close range (computer office or desk writing, etc.), a vision mark simulating a distance of 1-2 meters is selected to perform a diopter adjustment. If the user is active indoors, a vision mark simulating a distance of 5-8 meters is selected to perform a diopter adjustment. If the user is outdoors, a vision mark simulating a distance of more than 10 meters is selected to perform a diopter adjustment. The diopter adjustment is performed according to the object distance of the usage scenario to ensure the relaxation and comfort of the user's eyes to the greatest extent and protect the user's vision health. Then, the letter E at different positions in the array is lit up in turn on the display screen, and the lens barrels corresponding to the left and right eyes are adjusted to obtain the best visual effect. In some embodiments, in the vision mark array, adjacent vision marks are in different colors.

Step 2: colleting, an image of a real world by a camera, and transmitting to the main board 3 of the electronic myopia glasses.

Step 3: processing, an image signal by the main board 3 of the electronic myopia glasses, and comprising an image processing step and an image fusion step.

3-1: The image processing step comprises performing bad pixel correction, white balance, color correction, denoising, distortion correction, and color adjustment for the image; and

3-2: The image fusion step comprises fusing a parallax of left and right eye images, optical anti-distortion and anti-dispersion of binocular images, and binocular image rendering.

Step 4: transmitting, the image signal processed by the main board 3 to the microchip display screen 42 for display, the myopic users can use electronic myopia glasses to view the real world.

Embodiment 3

As shown in FIG. 4, the present disclosure provides electronic myopia glasses, comprising a glass front panel 1, a glass back cover 5 and temples 6, wherein the glass back cover 5 is provided with a glasses frame composed of a nose pad 51, and a focusing camera module 2, a main board 3 and a catadioptric optical display module 4 are arranged on the glasses frame. The focusing camera module 2 comprises a focusing camera 21, a camera fixing block 22 and a camera cover plate 23. The focusing camera 21 is installed on the glass front panel 1 by the camera fixing block 22, and the camera cover plate 23 is covered on the focusing camera 21. The main board 3 further comprises a heat dissipation board 31, and the heat dissipation board 31 is used for heat dissipation of the main board 3.

The catadioptric optical display module 4 comprises a catadioptric optical display lens group 41 and a microchip display screen 42. A distance between the catadioptric optical display lens group 41 and the display screen 42 can be adjusted to achieve the diopter adjustment.

The focusing camera module 2 and the catadioptric optical display module 4 are arranged to be adjustable in position according to the pupil distance of user. When in use, the focusing camera module 21 is arranged at a position of a vertical center line of an eyeball of a user, and two cameras are in a position of a same horizontal line. The field angle of the individual camera is greater than or equal to 110 degrees, and the overlap angle of the field angle of cameras is no less than 110. Each peripheral vision of the user is the same as existing resin or glass myopia glasses (natural light) at 30 degrees, and the catadioptric optical display lens group 41 and of the camera are selected accordingly to ensure that the user obtains the best field angle.

The temple 6 comprises an inner shell 61 and an outer shell 62, which have a hollow structure inside. The electronic myopia glasses further comprise a power supply module installed inside the temple 6, which is used to supply power to the binocular focusing camera module 2, the main board 3, and the optical display module 4.

The focusing camera module 2 collects images of the real world and transmits them to the main board 3. The main board 3 processes the image signals and transmits them to the microchip display screen 42 for display. The myopic user sees the images of the real world displayed by the microchip display screen 42 by the catadioptric optical display lens group 41.

A method for using electronic myopia glasses comprises:

step 1: adjusting, a diopter to match the user, using a lens barrel, by adjusting a distance between the catadioptric optical display lens group and the display screen or a distance between the internal glasses of the catadioptric optical display lens group; specifically comprises:

1-1: rotating, left and right lens barrels to a corresponding diopter scale according to a current myopia degree of the user;

1-2: displaying, a vision mark on one display screen, and fine-tuning the corresponding lens barrel until a clearest visual effect being achieved;

1-3: displaying, a vision mark on another display screen, and fine-tuning a corresponding lens barrel until the clearest visual effect being achieved; and

1-4: displaying, the vision marks on left and right display screens, and fine-tuning the lens barrels until the clearest visual effect being achieved for the eyes of the user.

When adjusting to match the diopter of the left eye of a user, the right display screen is black or the entire black pattern is displayed, or the right eye of the user is blocked.

When performing binocular diopter adjustment, the array-type vision mark is adopted, which can simulate vision mark at different distances, and can also collect vision mark at different distances and different array positions in advance by the focusing camera module. For example, letter E arranged in a nine-grid array or letter E arranged in a circle is used. First, a vision mark of a corresponding distance is selected according to the object distance in the usage scenario of the user to perform binocular diopter adjustment. For example, if the user mainly uses it at close range (computer office or desk writing, etc.), a vision mark simulating a distance of 1-2 meters is selected to perform a diopter adjustment. If the user is active indoors, a vision mark simulating a distance of 5-8 meters is selected to perform a diopter adjustment. If the user is outdoors, a vision mark simulating a distance of more than 10 meters is selected to perform a diopter adjustment. The diopter adjustment is performed according to the object distance of the usage scenario to ensure the relaxation and comfort of the user's eyes to the greatest extent and protect the user's vision health. Then, the letter E at different positions in the array is lit up in turn on the display screen, and the lens barrels corresponding to the left and right eyes are adjusted to obtain the best visual effect. In some embodiments, in the vision mark array, adjacent vision marks are in different colors.

Step 2: colleting, an image of a real world by a camera, and transmitting to the main board 3 of the electronic myopia glasses.

Step 3: processing, an image signal by the main board 3 of the electronic myopia glasses, and comprising an image processing step and an image fusion step.

3-1: The image processing step comprises performing bad pixel correction, white balance, color correction, denoising, distortion correction, and color adjustment for the image; and

3-2: The image fusion step comprises fusing a parallax of left and right eye images, optical anti-distortion and anti-dispersion of binocular images, and binocular image rendering.

Step 4: transmitting, the image signal processed by the main board 3 to the microchip display screen 42 for display, the myopic users can use electronic myopia glasses to view the real world.

Those skilled in the art should understand that the discussion of any of the above embodiments is merely exemplary and not intended to imply that the scope of the present disclosure (including the claims) is limited to these examples. Under the idea of the present disclosure, the technical features in the above embodiments or different embodiments can also be combined, and the steps can be implemented in any order. There are many other variations in the different aspects of the present disclosure as described above, which are not provided in the details for simplicity.

The present disclosure is intended to cover all such substitutions, modifications, and variations falling within the broad scope of the appended claims. Therefore, any omission, modification, equivalent replacement, improvement, etc. made within the spirit and principles of the present disclosure should be included in the scope of protection of the present disclosure.

What is claimed is:

1. Electronic myopia glasses, comprising a glasses frame, a focusing camera module arranged on the glasses frame, a main board and a catadioptric optical display module; the catadioptric optical display module comprises a microchip display screen and a catadioptric optical display lens group;
wherein a diopter adjustment of the electronic myopia glasses is achieved by adjusting a distance between the catadioptric optical display lens groups or a distance between the catadioptric optical display lens group and the display screen;
wherein the focusing camera module collects an image of a real world and transmits them to the main board, which processes an image signal and transmits it to the microchip display screen for display; the microchip display screen projects the image to a catadioptric optical display lens group, which changes an optical path to enlarge the image to a size of 1:1 with a real scene, and directly projects the optical path into eyes of a user, thus the user can see a scene that is 1:1 with the real world and a scene seen is naturally connected with a scene seen by a peripheral vision of the user without overlapping.

2. The electronic myopia glasses according to claim 1, wherein the glasses frame comprises a glass front panel, a glass back cover, and temples, the glass back cover is provided with a nose pad.

3. The electronic myopia glasses according to claim 1, wherein the focusing camera module is provided for each of left and right eyes, and is arranged at a position of a vertical center line of an eyeball of a user, and two cameras are in a position of a same horizontal line.

4. The electronic myopia glasses according to claim 1, further comprising a power supply module, which is configured to supply power to a binocular focusing camera module, the main board, and the optical display module; the power supply module is a split uninterrupted power supply module, each temple is provided with a power supply interface, and a battery of the power supply module is placed on a waist or a neck of the user, and is connected to the power supply interface of each temple by a power cord.

5. A method for using electronic myopia glasses, comprising:
step 1: adjusting, a diopter to match the user, by adjusting a distance between the catadioptric optical display lens groups or a distance between the catadioptric optical display lens group and the microchip display screen;
step 2: colleting, an image of a real world by a camera, and transmitting to the main board of the electronic myopia glasses;
step 3: processing, an images signal by the main board of the electronic myopia glasses; and
step 4: transmitting, the image signal processed by the main board to the microchip display screen for display, wherein the microchip display screen projects the image to a catadioptric optical display lens group, which changes an optical path to enlarge the image to a size of 1:1 with a real scene, and directly projects the optical path into eyes of the user, thus the user can see a scene that is 1:1 with the real world and a scene seen is naturally connected with a scene seen by a peripheral vision of the user without overlapping.

6. The method for using electronic myopia glasses according to claim 5, wherein the diopter adjustment of step 1 comprises a coarse adjustment and a fine adjustment, and specifically comprises:
11-1: rotating, left and right lens barrels to a corresponding diopter scale according to a current myopia degree of the user;
11-2: displaying, a vision mark on one display screen, and fine-tuning the corresponding lens barrel until a clearest visual effect being achieved; and
11-3: displaying, a vision mark on another display screen, and fine-tuning a corresponding lens barrel until the clearest visual effect being achieved.

7. The method for using electronic myopia glasses according to claim 6, further comprising:
11-4: displaying, vision marks on left and right display screens, and fine-tuning the lens barrels until the clearest visual effect being achieved for the eyes of the user.

8. The method for using electronic myopia glasses according to claim 6, wherein the vision mark is a letter, a number, a text, or an image.

9. The method for using electronic myopia glasses according to claim 5, wherein the step 1 further comprises: adjusting a focus by using the binocular focusing camera module according to an observation distance.

10. The method for using electronic myopia glasses according to claim 5, wherein the step
22 comprises an image processing step and an image fusion step, wherein the image processing step comprises performing bad pixel correction, white balance, color correction, denoising, distortion correction, and color adjustment for the image; and the image fusion step comprises fusing a parallax of left and right eye images, optical anti-distortion and anti-dispersion of binocular images, and binocular image rendering.
